(19) United States
(12) Patent Application Publication
(10) Pub. No.: US 2024/0030552 A1
(43) Pub. Date: Jan. 25, 2024

(54) PROTECTIVE LAYERS SEPARATING ELECTROACTIVE MATERIALS AND BINDER MATERIALS IN ELECTRODE AND METHODS OF FORMING THE SAME

(71) Applicant: GM GLOBAL TECHNOLOGY OPERATIONS LLC, Detroit, MI (US)

(72) Inventors: Dewen KONG, Shanghai (CN); Qili SU, Shanghai (CN); Meiyuan WU, Shanghai (CN); Haijing LIU, Shanghai (CN)

(73) Assignee: GM GLOBAL TECHNOLOGY OPERATIONS LLC, Detroit, MI (US)

(21) Appl. No.: 17/945,708

(22) Filed: Sep. 15, 2022

(30) Foreign Application Priority Data
Jul. 20, 2022 (CN) 202210853312.1

(51) Int. Cl. H01M 50/451; H01M 50/403; H01M 4/62

(52) U.S. Cl. CPC H01M 50/451; H01M 50/403; H01M 4/623

(57) ABSTRACT

An electrode assembly for an electrochemical cell that cycles lithium ions is provided. The electrode assembly includes one or more electroactive material layers including a plurality of electroactive material particles and a plurality of binder material fibers dispersed with the electroactive material particles. At least one electroactive material particle of the plurality may have a first protective layer coated thereon, and at least one binder material fiber of the plurality may have a second protective layer coated thereon. The first and second protective layers may be the same or different. The binder material fibers can include polytetrafluoroethylene (PTFE).

### CROSS-REFERENCE TO RELATED APPLICATIONS

This application claims the benefit and priority of Chinese Application No. 202210853312.1 filed Jul. 20, 2022. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, the use of polytetrafluoroethylene (PTFE) as an electrode binder is often desirable because the binder holds extra active materials permitting thicker electrodes, while also exhibiting higher temperature (e.g., greater than or equal to about 327° C.) and chemical resistance. However, undesirable side reactions often occur between the binder material and certain anode material, for example, during the lithium ion insertion process, resulting in reduced anodic Columbic efficiency and degradation of certain mechanical properties. Accordingly, it would be desirable to develop improved electrode materials, and methods of making and using the same, that can address these challenges.

### SUMMARY

This section provides a general summary of the disclosure, and is not a comprehensive disclosure of its full scope or all of its features.

The present disclosure relates to electrodes having first protective layers disposed over electroactive material particles, and also, second protective layers disposed over binder material fibers that are dispersed with the electroactive material particles to define the electrodes, as well as to methods of making and using the same.

In various aspects, the present disclosure provides an electrode assembly for an electrochemical cell that cycles lithium ions. The electrode may include a current collector and an electroactive material layer disposed on one or more sides of the current collector. The electroactive material layer may include a plurality of electroactive material particles and a plurality of binder material fibers dispersed with the electroactive material particles. At least one electroactive material particle of the plurality may have a first protective layer coated thereon. At least one binder material fiber of the plurality may have a second protective layer coated thereon.

In one aspect, the first and second protective layers may be polymeric layers including, for example, one or more monomers independently selected from the group consisting of: ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), oligomers of the same, and combinations thereof.

In one aspect, the first protective layer may be a continuous coating over each electroactive material particle of the plurality and may have a first average thickness greater than or equal to about 1 nanometer to less than or equal to about 300 nanometers. Similarly, the second protective layer may be a continuous coating over each binder material fiber of the plurality and may have a second average thickness greater than or equal to about 1 nanometers to less than or equal to about 300 nanometers.

In one aspect, the electroactive material layer may include greater than or equal to about 80 wt. % to less than or equal to about 99 wt. % of the electroactive material particles, and greater than or equal to about 0.01 wt. % to less than or equal to about 10 wt. % of the binder material fibers.

In one aspect, the electroactive material layer may include greater than or equal to about 0.01 wt. % to less than or equal to about 3 wt. % of the first protective layer, and greater than or equal to about 0.0001 wt. % to less than or equal to about 3 wt. % of the second protective layer.

In one aspect, the electroactive material layer may further include greater than 0 wt. % to less than or equal to about 10 wt. % of a conductive additive.

In one aspect, at least one of the binder material fibers of the plurality may include polytetrafluoroethylene (PTFE).

In one aspect, the electroactive material layer may have an average thickness greater than or equal to about 20 micrometers to less than or equal to about 2 millimeters.

In various aspects, the present disclosure provides a method for forming protective layers in an electrode. The method may include contacting an electrode including a plurality of electroactive material particles and a plurality of binder material particles to a precursor polymeric solution. The precursor polymeric solution may include a polymer precursor selected from the group consisting of: ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), oligomers of the same, and combinations thereof. The method may further include heating the electrode and precursor polymeric solution to a temperature greater than or equal to about 60° C. to less than or equal to about 300° C. for a period greater than or equal to about 1 minute to less than or equal to about 24 hours to form a protective layer over each of the electroactive material particles of the plurality and also over each binder fiber of a plurality of binder material fibers that are formed from the plurality of binder material particles.

In one aspect, the protective layer may be a continuous coating over each electroactive material particle of the plurality and each binder material fiber of the plurality. The protective layer over the electroactive material particles may have a first average thickness greater than or equal to about 1 nanometer to less than or equal to about 300 nanometers, and the protective layer over the binder material fibers may have a second average thickness greater than or equal to about 1 nanometers to less than or equal to about 300 nanometers.

In one aspect, the precursor polymeric solution may further include an initiator selected from the group consisting of: peroxide, benzoyl peroxide (BPO), azo compounds, peroxide with a reducing agent, and combinations thereof.

In one aspect, the precursor polymeric solution may include greater than or equal to about 0.05 wt. % to less than or equal to about 30 wt. % of the polymer precursor, and greater than or equal to about 0.01 wt. % to less than or equal to about 10 wt. % of the initiator.

In one aspect, the precursor polymeric solution may further include a solvent selected from the group consisting of: water, alcohol, glycol, isopropanol, ethylene carbonate (EC), dimethyl carbonate (DMC), ethylmethyl carbonate (EMC), diethyl carbonate (DEC), propylene carbonate (PC), acetonitrile (CAN), methyl alcohol (MA), gamma-butyrolactone (GBL), and combinations thereof.

In various aspects, the present disclosure provides a method for forming protective layers in an electrode. The method may include contacting an electroactive material mixture and a precursor polymeric solution. The electroactive material mixture may include a plurality of electroactive material particles and a plurality of binder material particles. The precursor polymeric solution may include a polymer precursor selected from the group consisting of: ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), oligomers of the same, and combinations thereof. The method may further include pressing the electroactive material mixture and the precursor polymeric solution to form a first protective layer over each of the electroactive material particles of the plurality and a second protective layer over each binder material fiber of a plurality of binder material fibers that are formed from the plurality of binder material particles.

In one aspect, the pressing may include heating the electroactive material mixture and the precursor polymerics solution to a temperature greater than or equal to about 60° C. to less than or equal to about 300° C.

In one aspect, the pressing may include, during the heating of the electroactive material mixture and the precursor polymeric solution, applying a pressure greater than or equal to about 1 psi to less than or equal to about 500 psi for a period greater than or equal to about 10 minutes to less than or equal to about 10 hours.

In one aspect, the method may further include drying the electrode and precursor polymeric solution to remove the solvent prior to the pressing of the electroactive material mixture

In one aspect, the drying may include heating the electrode and precursor polymeric solution to a temperature greater than or equal to about 80° C. to less than or equal to about 200° C. for a period greater than or equal to about 1 minute to less than or equal to about 24 hours

In one aspect, the first protective layer may be a continuous coating over each electroactive material particle of the plurality having a first average thickness greater than or equal to about 1 nanometer to less than or equal to about 300 nanometers, and the second protective layer may be a continuous coating over each binder material fiber of the plurality having a second average thickness greater than or equal to about 1 nanometers to less than or equal to about 300 nanometers.

In one aspect, the precursor polymeric solution may include greater than or equal to about 0.05 wt. % to less than or equal to about 30 wt. % of the polymer precursor, and may further include greater than or equal to about 0.01 wt. % to less than or equal to about 10 wt. % of an initiator selected from the group consisting of: peroxide, benzoyl peroxide (BPO), azo compounds, peroxide with a reducing agent, and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell including an electrode having a first protective layer disposed over at least one electroactive material particle of a plurality of electroactive material particles, and also, a second protective layer disposed over at least one binder material fiber of a plurality of binder material fibers that are dispersed with the electroactive material particles to define the electrode, in accordance with various aspects of the present disclosure;

FIG. 2 is a schematic of an example electrode having a first protective layer disposed over at least one electroactive material particle of a plurality of electroactive material particles, and also, a second protective layer disposed over at least one binder material fiber of a plurality of binder material fibers that are dispersed with the electroactive material particles to define the electrode, in accordance with various aspects of the present disclosure;

FIG. 3 is a flowchart illustrating an example method for forming an electrode having a first protective layer disposed over at least one electroactive material particle of a plurality of electroactive material particles, and also, a second protective layer disposed over at least one binder material fiber of a plurality of binder material fibers that are dispersed with the electroactive material particles to define the electrode, in accordance with various aspects of the present disclosure;

FIG. 4 is a flowchart illustrating another example method for forming an electrode having a first protective layer disposed over at least one electroactive material particle of a plurality of electroactive material particles, and also, a second protective layer disposed over at least one binder material fiber of a plurality of binder material fibers that are dispersed with the electroactive material particles to define the electrode, in accordance with various aspects of the present disclosure;

FIG. 5 is a flowchart illustrating another example method for forming an electrode having a first protective layer disposed over at least one electroactive material particle of a plurality of electroactive material particles, and also, a second protective layer disposed over at least one binder material fiber of a plurality of binder material fibers that are dispersed with the electroactive material particles to define the electrode, in accordance with various aspects of the present disclosure; and

FIG. 6 is a graphical illustration demonstrating the Columbic efficiency of the example cell including an having a first protective layer disposed over at least one electroactive material particle of a plurality of electroactive material particles, and also, a second protective layer disposed over at least one binder material fiber of a plurality of binder material fibers that are dispersed with the electroactive material particles to define the electrode, in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including electrodes having first protective layers disposed over electroactive material particles, and also, second protective layers disposed over binder material fibers that are dispersed with the electroactive material particles to define the electrodes, as well as to methods of making and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

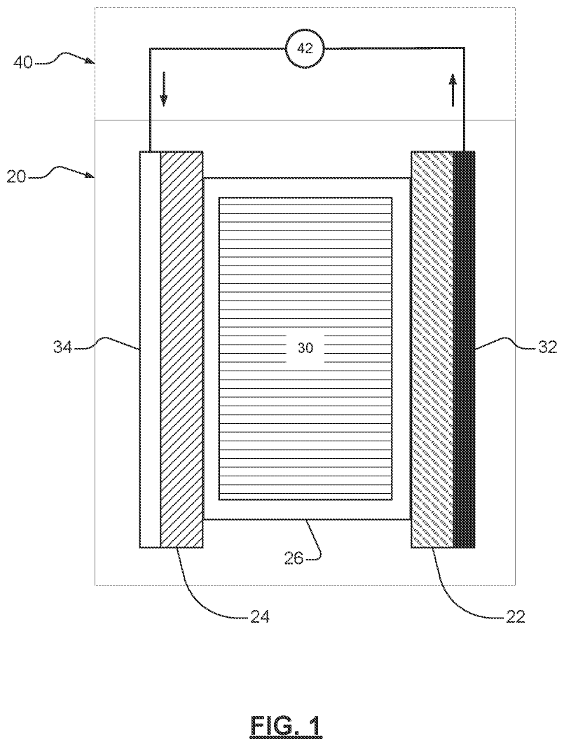

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution (e.g., >1 M) that includes a lithium salt dissolved in an organic solvent or a mixture of organic solvents.

Numerous conventional non-aqueous liquid electrolyte 30 solutions may be employed in the battery 20. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiFSI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) layer and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte layer may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The positive electrode 24 may be formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 20 μm to less than or equal to about 2,000 μm, optionally greater than or equal to about 20 μm to less than or equal to about 1,000 μm, and in certain aspects, optionally greater than or equal to about 20 μm to less than or equal to about 300 μm.

In various aspects, the positive electroactive material may include, for example, a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material may include, for example, an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material may include, for example, a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material may include, for example, a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material may include, for example, a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations, the positive electrode 24 may include, for example, a combination of positive electroactive materials. For example, the positive electrode 24 may include one or more layered oxides, one or more olivine-type oxides, one or more monoclinic-type oxides, one or more spinel-type oxide, one or more tavorite, or combinations thereof.

In certain variations, the positive electroactive material may be optionally intermingled (e.g., slurry casted) with an electronically conductive material that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 95 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE) copolymers, polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel, or other metal particles (including metal wires and metal oxides), and/or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 is formed from a lithium host material that is capable of functioning as a negative terminal of a lithium-ion battery. In various aspects, the negative electrode 22 may be defined by a plurality of negative electroactive material particles and a plurality of binder material fibers. For example, the negative electrode 22 may include greater than or equal to about 80 wt. % to less than or equal to about 99 wt. %, and in certain aspects, optionally greater than or equal to about 90 wt. % to less than or equal to about 98 wt. %, of the negative electroactive material particles; and greater than or equal to about 0.01 wt. % to less than or equal to about 10 wt. %, and in certain aspects, optionally greater than or equal to about 0.05 wt. % to less than or equal to about 3 wt. %, of the binder material fibers.

The negative electroactive material particles together with the binder material fibers may be disposed in one or more layers so as to define the three-dimensional structure of the negative electrode 22. The electrolyte 30 may be introduced, for example after cell assembly, and contained within pores of the negative electrode 22. For example, the negative electrode 22 may have a porosity greater than or equal to about 20 vol. % to less than or equal to about 60 vol. %, and in certain aspects, optionally greater than or equal to about 25 vol. % to less than or equal to about 45 vol. %. In other variations, the negative electrode 22 may include a plurality of solid-state electrolyte particles. In each instance, the negative electrode 22 (including the one or more layers) may have an areal capacity greater than or equal to about 2.5 mAh/cm² to less than or equal to about 50 mAh/cm², and in certain aspects, optionally greater than or equal to about 4.5 mAh/cm² to less than or equal to about 10 mAh/cm². In certain variations, the negative electrode may have an areal capacity variation of ±5%.

In various aspects, the negative electroactive material may include, for example, carbonaceous materials, such as graphite, hard carbon, soft carbon, and the like. In other variations, the negative electroactive material may be a silicon-containing electroactive material including, for example, silicon, silicon alloys, and/or silicon-graphite composites. In each instance, the silicon-containing electroactive material may be pre-lithiated. In still other variations, the negative electroactive material may include, for example, metal oxides, such as V₂O₅, SnO, Co₃O₄, and the like. In still other variations, the negative electroactive material may include, for example, metal sulfides, such as FeS. In further variations, the negative electrode 22 may include, for example, a combination of negative electroactive materials. For example, the negative electrode 22 may include one or more carbonaceous materials, one or more silicon-containing materials, one or more pre-lithiated silicon-containing materials, one or more metal oxides, one or more metal sulfides, or combinations thereof.

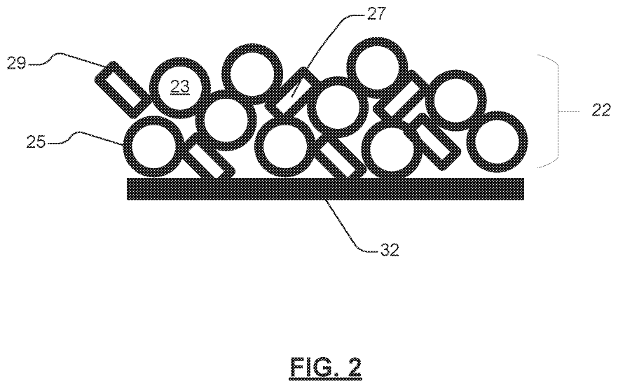

In each instance, for example, as illustrated in FIG. 2, at least one of the negative electroactive material particles 23 of the plurality may be coated with a first protective layer 25. The negative electroactive material particles 23 may have an average particle size greater than or equal to about 1 μm to less than or equal to about 50 μm, and in certain aspects, optionally greater than or equal to about 4 μm to less than or equal to about 25 μm. The first protective layer 25 may be substantially continuous and uniform particle coating that covers greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.5%, of a total exposed surface area of the negative electroactive material particle 23. In this manner, the first protective layer 25 can isolate the negative electroactive material particle 23 so as to help to reduce or eliminate side reactions between the negative electroactive material particle 23 and other cell materials, like the binder material fibers 27.

The first protective layer 25 may be ionically conductive, polymeric layers prepared using an in-situ polymerization process, a component mixing process, or a powder treatment process as further detailed below. In each instance, one or more monomers are polymerized. The monomers may include, for example, ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), and/or oligomers of the same. The first protective layer 25 may have an average thickness greater than or equal to about 1 nanometer (nm) to less than or equal to about 300 nm, and in certain aspects, optionally greater than or equal to about 5 nm to less than or equal to about 20 nm; and ionic conductivities greater than or equal to about 1×10⁻⁷ S/cm to less than or equal to about 1×10⁻¹ S/cm, and in certain aspects, optionally greater than or equal to about 1×10⁻⁵ S/cm to less than or equal to about 1×10⁻³ S/cm. The negative electrode 22 may include greater than or equal to about 0.01 wt. % to less than or equal to about 3 wt. %, and in certain aspects, optionally greater than or equal to about 0.05 wt. % to less than or equal to about 1.5 wt. %, of the first protective layer 25.

Each of the binder material fibers 27 may having an average diameter greater than or equal to about 50 nm to less than or equal to about 500 nm and may include, for example, polytetrafluoroethylene (PTFE), fluorinated ethylene propylene (FEP), perfluoroalkoxy alkanes (PFA), ethylene tetrafluoroethylene (ETFE), or combinations thereof. In certain variations, as illustrated, at least one of the binder material fibers 27 of the plurality may be coated with a second protective layer 29. Like the first protective layer 25, the second protective layer 27 may be a substantially continuous and uniform particle coating that covers greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.5%, of a total exposed surface area of the binder material fiber. In this manner, the second protective layer 29 may isolate the binder material fiber 27 so as to help to reduce or eliminate side reactions between the binder material fiber 27 and other cell materials, like the negative electroactive material particles 23.

As further detailed below, the second protective layer 29 may be prepared concurrently with the first protective layer 25. Like the first protective layer 25, the second protective layer 29 may be prepared by polymerizing one or more monomers selected from ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), and/or oligomers of the same. The second protective layer 29 may have an average thickness greater than or equal to about 1 nm to less than or equal to about 300 nm, and in certain aspects, optionally greater than or equal to about 5 nm to less than or equal to about 20 nm; and ionic conductivities greater than or equal to about 1×10⁻⁷ S/cm to less than or equal to about 1×10⁻¹ S/cm, and in certain aspects, optionally greater than or equal to about 1×10⁻⁵ S/cm to less than or equal to about 1×10⁻³ S/cm. The negative electrode 22 may include greater than or equal to about 0.0001 wt. % to less than or equal to about 3 wt. % of the second protective layer 29.

Although not illustrated, it should be recognized that, in certain variations, the negative electroactive material and the binder material fibers may be optionally intermingled (e.g., slurry casted) with an electronically conductive material (i.e., conductive additive) that improve the electronically conductivity of the negative electrode. For example, the negative electrode 22 may include greater than or equal to about 0 wt. % to less than or equal to about 10 wt. %, and in certain aspects, optionally greater than or equal to about 1 wt. % to less than or equal to about 5 wt. %, of the electronically conducting material. The electronically conducting material as included in the negative electrode 22 may be the same as or different form the electronically conducting material as included in the positive electrode 24.

With renewed reference to FIG. 1, in each instance, the negative electrode 22 may have an areal capacity greater than or equal to about 5 mAh/cm² to less than or equal to about 50 mAh/cm², and in certain aspects, optionally 5 mAh/cm² to less than or equal to about 10 mAh/cm². The negative electrode 22 may have an areal capacity variation of about ±5%. The negative electrode 22 may have a press density greater than or equal to about 1.0 g/cc to less than or equal to about 3.0 g/cc, and in certain aspects, optionally greater than or equal to about 1.4 g/cc to less than or equal to about 2.0 g/cc. The negative electrode 22 may have a press density variation of about ±3%. The negative electrode 22 may have a single surface loading greater than or equal to about 5 mAh/cm².

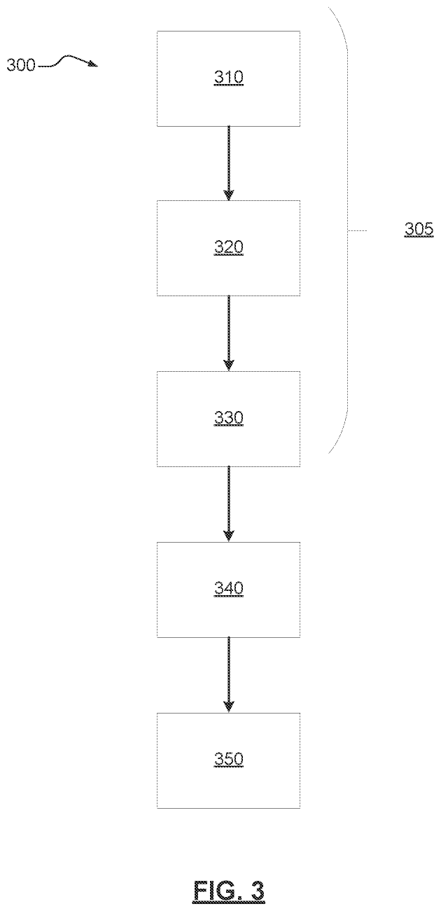

In various aspects, the present disclosure provides methods for preparing material particle coatings in an electrode, like the first and second protective coatings 25, 29 illustrated in FIG. 2. In certain variations, the material coatings may be prepared using an in-situ polymerization process. As illustrated in FIG. 3, an in-situ polymerization process 300 may include contacting 350 one or more sides of an electrode assembly to a precursor polymeric solution. The contacting 350 may include dipping the electrode assembly into a bath including the precursor polymeric solution. In certain variations, the method 300 may include preparing 305 the electrode assembly. Preparing 305 the electrode assembly may include preparing 310 an electrode slurry by contacting an electroactive material and a binder material (and in certain aspects, optionally a conductive additive) in a solvent. Preparing 305 the electrode assembly may also include disposing 320 the slurry near or on one or more surfaces of a current collector and removing 330 the solvent to form the electrode assembly.

In each variation, the precursor polymeric solution may include a polymer precursor, an initiator, and a solvent. For example, the precursor polymeric solution may include greater than or equal to about 0.05 wt. % to less than or equal to about 30 wt. %, and in certain aspects, optionally greater than or equal to about 0.5 wt. % to less than or equal to about 5 wt. %, of the polymer precursor; greater than or equal to about 0.01 wt. % to less than or equal to about 10 wt. %, and in certain aspects, optionally greater than or equal to about 0.05 wt. % to less than or equal to about 1 wt. %, of the initiator; and greater than or equal to about 70 wt. % to less than or equal to about 99.5 wt. %, and in certain aspects, optionally greater than or equal to about 90 wt. % to less than or equal to about 99.4 wt. %, of a solvent.

The polymer precursor may include, for example, ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), and/or oligomers of the same. The initiator may include, for example, peroxide (e.g., di(4-tert-butylcyclohexyl)peroxydicarbonate)), benzoyl peroxide (BPO), azo compounds (e.g., azodicyandiamide (ANBI)), peroxide with a reducing agent (e.g., low-valence metal salts, such as S₂O₄²⁻+Fe²⁺, Cr³⁺, Cu⁺, and the like), and combinations thereof. The solvent may include, for example, aqueous and organic alcohol type, ester, ether, such as water, alcohol, glycol, isopropanol, ethylene carbonate (EC), dimethyl carbonate (DMC), ethylmethyl carbonate (EMC), diethyl carbonate (DEC), propylene carbonate (PC), acetonitrile (CAN), methyl alcohol (MA), gamma-butyrolactone (GBL), and the like. In certain variations, the method 300 may include preparing 340 the precursor solution by contacting the polymer precursor, the initiator, and the solvent.

The method 300 further includes heating the electrode assembly including the precursor polymeric solution to trigger thermal polymerization of the polymer precursor (i.e., monomers) and remove the solvent. The electrode assembly including the precursor polymeric solution may be heated to a temperature greater than or equal to about 60° C. to less than or equal to about 300° C., and in certain aspects, optionally greater than or equal to about 80° C. to less than or equal to about 180° C. for a period greater than or equal to about 1 minute to less than or equal to about 24 hours, and in certain aspects, optionally greater than or equal to about 10 minutes to less than or equal to about 5 hours.

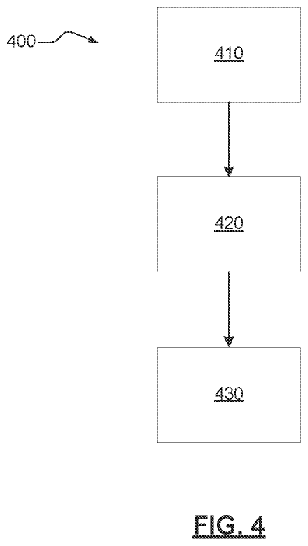

In other variations, the material coatings may be prepared using a component mixing process. As illustrated in FIG. 4, a component mixing process 400 may include contacting 410 an electroactive material and a binder material, and in certain aspects, optionally a conductive additive to form a first admixture. In certain variations, the contacting may include mixing together the electroactive material, the binder material, and optionally the conductive additive to form the first admixture. The method 400 may further include contacting 420 a polymer precursor, and initiator, and a solvent to the first admixture to form a second admixture. The polymer precursor, initiator, and solvent may be contacted 420 to the first admixture concurrently or consecutively. For example, in certain variation, the polymer precursor, initiator, and solvent may be contacted to form a precursor solution and the precursor solution may be contacted 420 to the first admixture to form the second admixture.

In each instance, the polymer precursor may include, for example, ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), and/or oligomers of the same. The initiator may include, for example, peroxide (e.g., di(4-tert-butylcyclohexyl)peroxydicarbonate)), benzoyl peroxide (BPO), azo compounds (e.g., azodicyandiamide (ANBI)), peroxide with a reducing agent (e.g., low-valence metal salts, such as S₂O₄²⁻+Fe²⁺, Cr³⁺, Cu⁺, and the like), and combinations thereof. The solvent may include, for example, aqueous and organic alcohol type, ester, ether, such as water, alcohol, glycol, isopropanol, ethylene carbonate (EC), dimethyl carbonate (DMC), ethylmethyl carbonate (EMC), diethyl carbonate (DEC), propylene carbonate (PC), acetonitrile (CAN), methyl alcohol (MA), gamma-butyrolactone (GBL), and the like.

The second admixture may include greater than or equal to about 0.05 wt. % to less than or equal to about 30 wt. %, and in certain aspects, optionally greater than or equal to about 0.5 wt. % to less than or equal to about 5 wt. %, of the polymer precursor; greater than or equal to about 0.01 wt. % to less than or equal to about 10 wt. %, and in certain aspects, optionally greater than or equal to about 0.05 wt. % to less than or equal to about 1 wt. %, of the initiator; and greater than or equal to about 70 wt. % to less than or equal to about 99.5 wt. %, and in certain aspects, optionally greater than or equal to about 90 wt. % to less than or equal to about 99.4 wt. %, of a solvent.

The method 400 further includes subjecting 430 the second admixture to an electrode film fabrication process, such as hot pressing during which polymerization is triggered. For example, in certain variations, a pressure greater than or equal to about 1 psi to less than or equal to about 500 psi, and in certain aspects, optionally greater than or equal to about 50 psi to less than or equal to about 200 psi, may be applied to the second admixture at a temperature greater than or equal to about 60° C. to less than or equal to about 300° C., and in certain aspects, optionally greater than or equal to about 80° C. to less than or equal to about 200° C. for a period greater than or equal to about 10 minutes to less than or equal to about 10 hours, and in certain aspects, optionally greater than or equal to about 30 minutes to less than or equal to about 4 hours.

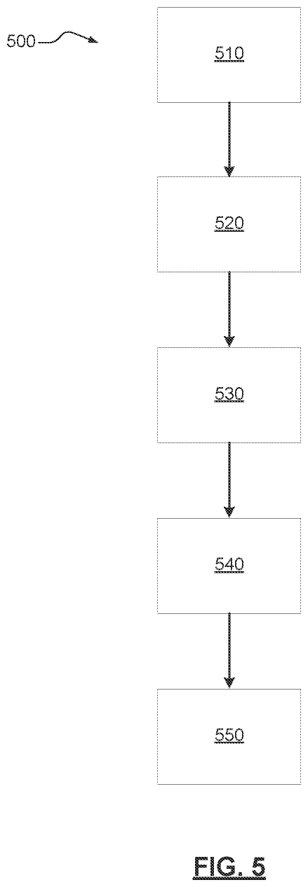

In other variations, the material coatings may be prepared using a powder treatment process. As illustrated in FIG. 5, a powder treatment process 500 may include contacting 510 an electroactive material and a binder material, and in certain aspects, optionally a conductive additive to form a first admixture. In certain variations, the contacting may include mixing together the electroactive material, the binder material, and optionally the conductive additive to form the first admixture. The method 500 may further include contacting 520 a polymer precursor, and initiator, and a solvent to the first admixture to form a second admixture. The polymer precursor, initiator, and solvent may be contacted 520 to the first admixture concurrently or consecutively. For example, in certain variation, the polymer precursor, initiator, and solvent may be contacted to form a precursor solution and the precursor solution may be contacted 520 to the first admixture to form the second admixture.

In each instance, the polymer precursor may include, for example, ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), and/or oligomers of the same. The initiator may include, for example, peroxide (e.g., di(4-tert-butylcyclohexyl)peroxydicarbonate)), benzoyl peroxide (BPO), azo compounds (e.g., azodicyandiamide (ANBI)), peroxide with a reducing agent (e.g., low-valence metal salts, such as S₂O₄²⁻+Fe²⁺, Cr³⁺, Cu⁺, and the like), and combinations thereof. The solvent may include, for example, aqueous and organic alcohol type, ester, ether, such as water, ethanol type and ester type, ethylene carbonate (EC), dimethyl carbonate (DMC), ethylmethyl carbonate (EMC), diethyl carbonate (DEC), propylene carbonate (PC), acetonitrile (CAN), methyl alcohol (MA), gamma-butyrolactone (GBL), and the like.

The second admixture may include greater than or equal to about 0.05 wt. % to less than or equal to about 30 wt. %, and in certain aspects, optionally greater than or equal to about 0.5 wt. % to less than or equal to about 5 wt. %, of the polymer precursor; greater than or equal to about 0.01 wt. % to less than or equal to about 10 wt. %, and in certain aspects, optionally greater than or equal to about 0.05 wt. % to less than or equal to about 1 wt. %, of the initiator; and greater than or equal to about 70 wt. % to less than or equal to about 99.5 wt. %, and in certain aspects, optionally greater than or equal to about 90 wt. % to less than or equal to about 99.4 wt. %, of a solvent.

The method 500 further includes drying 530 the second admixture to remove the solvent. For example, the drying 530 may include heating the second admixture at a temperature greater than or equal to about 80° C. to less than or equal to about 200° C., and in certain aspects, optionally greater than or equal to about 80° C. to less than or equal to about 150° C. for a period greater than or equal to about 1 minute to less than or equal to about 24 hours, and in certain aspects, optionally greater than or equal to about 10 minute to less than or equal to about 4 hours.

The method 500 further includes subjecting 430 the second admixture to an electrode film fabrication process, such as hot pressing or solvent-free process, during which polymerization is triggered. For example, in certain variations, a pressure greater than or equal to about 1 psi to less than or equal to about 500 psi, and in certain aspects, optionally greater than or equal to about 50 psi to less than or equal to about 200 psi, may be applied to the second admixture at a temperature greater than or equal to about 60° C. to less than or equal to about 300° C., and in certain aspects, optionally greater than or equal to about 80° C. to less than or equal to about 200° C. for a period greater than or equal to about 10 minutes to less than or equal to about 10 hours, and in certain aspects, optionally greater than or equal to about 30 minutes to less than or equal to about 4 hours.

Certain features of the current technology are further illustrated in the following non-limiting examples.

### Example 1

Example batteries and battery cells may be prepared in accordance with various aspects of the present disclosure. An example cell 610 may include a negative electrode having first protective layers disposed over electroactive material particles, and also, second protective layers disposed over binder material fibers that are dispersed with the electroactive material particles to define the negative electrode. A comparative cell 420 may include similar electroactive material particles and binder material fibers that define the negative electrode, however, the comparative cell 420 omits the first and second protective layers. In each instance, the electroactive material particles may include graphite.

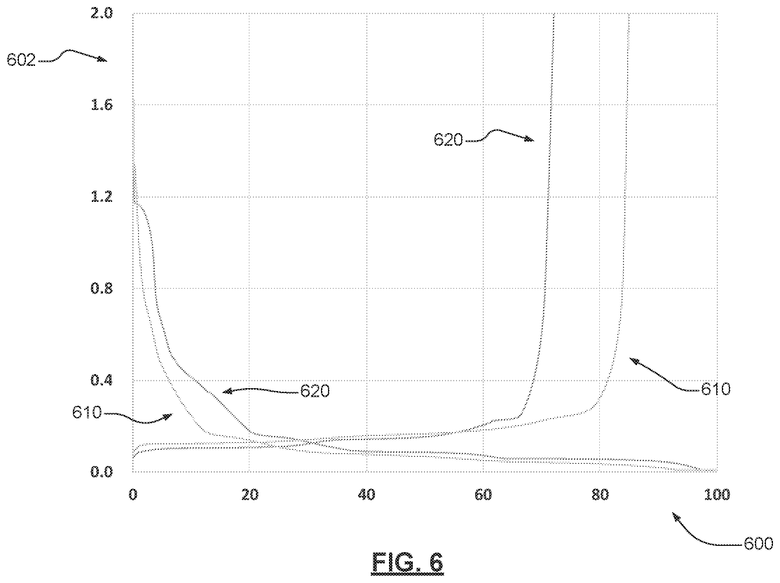

FIG. 6 is a graphical illustration demonstrating the Columbic efficiency of the example cell 610 as compared to the comparative cell 620, where the x-axis 600 represents state of charge (%), and the y-axis 602 represents voltage (V). As illustrated, the example cell 610 has improved performance as compared to the comparative cell 620. For example, the example cell 610 has a Columbic efficiency of about 84.9%, while the comparative cell 620 has a Columbic efficiency of about 69.5%.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode assembly for an electrochemical cell that cycles lithium ions, the electrode comprising:
a current collector; and
an electroactive material layer disposed on one or more sides of the current collector, the electroactive material layer comprising:
a plurality of electroactive material particles, each electroactive material particle of the plurality having a first protective layer coated thereon; and
a plurality of binder material fibers dispersed with the electroactive material particles, each binder material fiber of the plurality having a second protective layer coated thereon.

2. The electrode assembly of claim 1, wherein the first and second protective layers are polymeric layers each comprising one or more monomers independently selected from the group consisting of: ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), oligomers of the same, and combinations thereof.

3. The electrode assembly of claim 1, wherein the first protective layer is a continuous coating over each electroactive material particle of the plurality having a first average thickness greater than or equal to about 1 nanometer to less than or equal to about 300 nanometers, and the second protective layer is a continuous coating over each binder material fiber of the plurality having a second average thickness greater than or equal to about 1 nanometers to less than or equal to about 300 nanometers.

4. The electrode assembly of claim 1, wherein the electroactive material layer comprises:
greater than or equal to about 80 wt. % to less than or equal to about 99 wt. % of the electroactive material particles; and
greater than or equal to about 0.01 wt. % to less than or equal to about 10 wt. % of the binder material fibers.

5. The electrode assembly of claim 4, wherein the electroactive material layer comprises:
greater than or equal to about 0.01 wt. % to less than or equal to about 3 wt. % of the first protective layer; and
greater than or equal to about 0.0001 wt. % to less than or equal to about 3 wt. % of the second protective layer.

6. The electrode assembly of claim 4, wherein the electroactive material layer further comprises:
greater than 0 wt. % to less than or equal to about 10 wt. % of a conductive additive.

7. The electrode assembly of claim 1, wherein at least one of the binder material fibers of the plurality comprises polytetrafluoroethylene (PTFE).

8. The electrode assembly of claim 1, wherein the electroactive material layer has an average thickness greater than or equal to about 20 micrometers to less than or equal to about 2 millimeters.

9. A method for forming protective layers in an electrode, the method comprising:
contacting an electrode comprising a plurality of electroactive material particles and a plurality of binder material particles to a precursor polymeric solution, the precursor polymeric solution comprising a polymer precursor selected from the group consisting of: ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), oligomers of the same, and combinations thereof; and
heating the electrode and precursor polymeric solution to a temperature greater than or equal to about 60° C. to less than or equal to about 300° C. for a period greater than or equal to about 1 minute to less than or equal to about 24 hours to form a protective layer over each of the electroactive material particles of the plurality and over each binder material fiber of a plurality of binder material fibers formed from the plurality of binder material particles.

10. The method of claim 9, wherein the protective layer is a continuous coating over each electroactive material particle of the plurality and each binder material fiber of the plurality, the protective layer over the electroactive material particles having a first average thickness greater than or equal to about 1 nanometer to less than or equal to about 300 nanometers, and the protective layer over the binder material fibers having a second average thickness greater than or equal to about 1 nanometers to less than or equal to about 300 nanometers.

11. The method of claim 9, wherein the precursor polymeric solution further comprises an initiator selected from the group consisting of: peroxide, benzoyl peroxide (BPO), azo compounds, peroxide with a reducing agent, and combinations thereof.

12. The method of claim 11, wherein the precursor polymeric solution comprises:
greater than or equal to about 0.05 wt. % to less than or equal to about 30 wt. % of the polymer precursor; and
greater than or equal to about 0.01 wt. % to less than or equal to about 10 wt. % of the initiator.

13. The method of claim 11, wherein the precursor polymeric solution further comprises a solvent selected from the group consisting of: water, alcohol, glycol, isopropanol, ethylene carbonate (EC), dimethyl carbonate (DMC), ethylmethyl carbonate (EMC), diethyl carbonate (DEC), propylene carbonate (PC), acetonitrile (CAN), methyl alcohol (MA), gamma-butyrolactone (GBL), and combinations thereof.

14. A method for forming protective layers in an electrode, the method comprising:
contacting an electroactive material mixture and a precursor polymeric solution, the electroactive material mixture comprising a plurality of electroactive material particles and a plurality of binder material particles, the precursor polymeric solution comprises a polymer precursor selected from the group consisting of: ethylene oxide (EO), vinylidene fluoride (VDF), vinylidene fluoride-hexafluoropropylene (VDF-HFP), propylene oxide (PO), acrylonitrile (AN), methacrylonitrile (MAN) ethylene glycol (EG), trimethylene carbonate (TMC), methyl methacrylate (MMA), oligomers of the same, and combinations thereof; and
pressing the electroactive material mixture and the precursor polymeric solution to form a first protective layer over each of the electroactive material particles of the plurality and a second protective layer over each binder material fibers of a plurality of binder material fibers formed from the plurality of binder material particles.

15. The method of claim 14, wherein the pressing comprises heating the electroactive material mixture and the precursor polymerics solution to a temperature greater than or equal to about 60° C. to less than or equal to about 300° C.

16. The method of claim 15, wherein the pressing comprises, during the heating of the electroactive material mixture and the precursor polymeric solution, applying a pressure greater than or equal to about 1 psi to less than or equal to about 500 psi for a period greater than or equal to about 10 minutes to less than or equal to about 10 hours.

17. The method of claim 14, wherein the method further comprises:
drying the electrode and precursor polymeric solution to remove the solvent prior to the pressing of the electroactive material mixture

18. The method of claim 17, wherein the drying comprises heating the electrode and precursor polymeric solution to a temperature greater than or equal to about 80° C. to less than or equal to about 200° C. for a period greater than or equal to about 1 minute to less than or equal to about 24 hours

19. The method of claim 14, wherein the first protective layer is a continuous coating over each electroactive material particle of the plurality having a first average thickness greater than or equal to about 1 nanometer to less than or equal to about 300 nanometers, and the second protective layer is a continuous coating over each binder material fiber of the plurality having a second average thickness greater than or equal to about 1 nanometers to less than or equal to about 300 nanometers.

20. The method of claim 14, wherein the precursor polymeric solution comprises greater than or equal to about 0.05 wt. % to less than or equal to about 30 wt. % of the polymer precursor, and further comprises greater than or equal to about 0.01 wt. % to less than or equal to about 10 wt. % of an initiator selected from the group consisting of: peroxide, benzoyl peroxide (BPO), azo compounds, peroxide with a reducing agent, and combinations thereof.
